(19) United States
(12) Patent Application Publication
(10) Pub. No.: US 2025/0024508 A1
(43) Pub. Date: Jan. 16, 2025

(54) METHOD AND APPARATUS FOR RANDOM ACCESS IN NON-TERRESTRIAL NETWORK

(71) Applicant: Lenovo (Beijing) Limited, Beijing (CN)

(72) Inventors: Min Xu, Beijing (CN); Ran Yue, Beijing (CN); Jing Han, Beijing (CN); Lianhai Wu, Beijing (CN); Jie Hu, Beijing (CN)

(73) Assignee: Lenovo (Beijing) Limited, Beijing (CN)

(21) Appl. No.: 18/711,516

(22) PCT Filed: Nov. 19, 2021
(86) PCT No.: PCT/CN2021/131805

§ 371 Date: May 17, 2024

(51) Int. Cl. H04W 74/0833; H04W 56/00

(52) U.S. Cl. CPC H04W 74/0833; H04W 56/0055

(57) ABSTRACT

The present application relates to a method and apparatus for random access in non-terrestrial networks (NTN). An embodiment of the present disclosure provides a user equipment (UE), which includes: a transceiver configured to: receive configuration information associated with repetition of a random access message; and a processor configured to: determine whether to transmit a request for the random access message with repetition, or determine whether to transmit the random access message with repetition for a random access procedure based on the configuration information, wherein the configuration information at least indicates one of the following: a signal strength parameter and a signal strength offset associated with the signal strength parameter; a non-signal-strength parameter; a non-signal-strength parameter and a non-signal-strength offset associated with the non-signal-strength parameter; or a signal strength parameter and a non-signal-strength parameter.

### TECHNICAL FIELD

Embodiments of the present disclosure relate to wireless communication technology, and more particularly, relates to a method and apparatus for random access (RA) in non-terrestrial network (NTN).

### BACKGROUND OF THE INVENTION

Coverage is one of the key factors that network operators consider when commercializing cellular communication networks due to its direct impact on service quality and expenditure. To enhance the coverage, Msg3 repetition is considered. For example, for a user equipment (UE), when the reference signal receiving power (RSRP) measurement on downlink (DL) path loss reference signals is below a threshold, it can transmit Msg1 over a dedicated set of physical random access channel (PRACH) resource to indicate its request for Msg3 repetition.

However, in an NTN cell, the antenna is on board satellites with higher altitude than terrestrial network (TN), and different weathers (e.g., rain, fog, or cloud) may cause variable degrees of signal fading. As a result, the RSRP difference between a UE at a cell center and a UE at a cell edge is typically insignificant. Accordingly, due to the smaller RSRP difference in a cell and satellite movement in NTN, it may be difficult to configure an appropriate RSRP threshold for UE to request Msg3 repetition.

Thus, the coverage problem is still not well solved, and enhancements on coverages are desired.

### SUMMARY

According to some embodiments of the present disclosure, the UE includes: a transceiver configured to: receive configuration information associated with repetition of a random access message; and a processor configured to: determine whether to transmit a request for the random access message with repetition, or determine whether to transmit the random access message with repetition for a random access procedure based on the configuration information, wherein the configuration information at least indicates one of the following: a signal strength parameter and a signal strength offset associated with the signal strength parameter; a non-signal-strength parameter; a non-signal-strength parameter and a non-signal-strength offset associated with the non-signal-strength parameter; or a signal strength parameter and a non-signal-strength parameter.

In some embodiments of the present disclosure, the random access message is Msg3 in a 4-step random access procedure or MsgA payload for 2-step random access procedure.

In some embodiments of the present disclosure, the signal strength parameter is a reference signal receiving power (RSRP) threshold.

In some embodiments of the present disclosure, the processor is further configured to: determine to transmit the request for the random access message with repetition or transmit the random access message with repetition in the case that a receiving signal strength at the UE is smaller than the signal strength parameter, or smaller than the signal strength parameter plus the signal strength offset.

In some embodiments of the present disclosure, the non-signal-strength parameter comprises at least one of the following: a time threshold; a distance threshold; a set of geographical areas; a set of logical channels; a set of quality of service (QOS) indicators; a set of random access events; a set of UE capabilities; or a set of UE information availability.

In some embodiments of the present disclosure, the processor is further configured to: determine to transmit the request for the random access message with repetition or transmit the random access message with repetition in the case that at least one of the following conditions is met: a propagation delay is larger than or smaller than the time threshold; an estimated timing advance is larger than the time threshold; a distance is larger than the distance threshold; the UE being inside of any of the set of geographical areas; a random access procedure being triggered by a logic channel in the set of logic channels; the random access procedure being triggered by at least one service with a QoS indicator in the set of QoS indicators; the random access procedure being triggered by at least one event in the set of random access events; the UE having at least one capability in the set of UE capabilities; or the UE having available UE information in the set of information availability.

In some embodiments of the present disclosure, the non-signal-strength offset comprises at least one of the following offset: a time offset associated with the time threshold, or a distance offset associated with the distance threshold.

In some embodiments of the present disclosure, the processor is further configured to: determine to transmit the request for the random access message with repetition or transmit the random access message with repetition in the case that at least one of the following conditions is met: a propagation delay is larger than or smaller than the time threshold plus the time offset; an estimated timing advance is larger than the time threshold plus the time offset; or a distance is larger than the distance threshold plus the distance offset.

In some embodiments of the present disclosure, the transceiver is further configured to: receive the configuration information in a system information block or a dedicated signaling.

In some embodiments of the present disclosure, the processor is further configured to: determine a type of the random access procedure before determining whether to transmit the random access message with repetition; or determine a type of the random access procedure after determining whether to transmit the random access message with repetition.

In some embodiments of the present disclosure, in the case of determining to transmit a request for the random access message with repetition or transmit the random access message with repetition and a time offset being applied at a start of a contention resolution timer, the processor is further configured to: not start the contention resolution timer not running in response to a transmission of random access message occurring and the contention resolution timer.

In some embodiments of the present disclosure, in the case of determining to transmit a request for the random access message with repetition or transmit the random access message with repetition a time offset being applied at a start of a contention resolution timer, the processor is further configured to: restart the contention resolution timer being running in response to a transmission of random access message with repetition occurring.

In some embodiments of the present disclosure, the configuration information includes at most two sets of configuration for supplement uplink (SUL) and normal uplink (NUL) frequencies, respectively.

According to some other embodiments of the present disclosure, a base station (BS) includes: a transceiver configured to: transmit configuration information associated with repetition of a random access message; and a processor configured to: detect a request for the random access message with repetition; or detect the random access message with repetition or not for a random access procedure; wherein the configuration information at least indicates one of the following: a signal strength parameter and a signal strength offset associated with the signal strength parameter; a non-signal-strength parameter; a non-signal-strength parameter and a non-signal-strength offset associated with the non-signal-strength parameter; or a signal strength parameter and a non-signal-strength parameter.

In some embodiments of the present disclosure, the random access message is Msg3 in a 4-step random access procedure or MsgA payload for 2-step random access procedure.

In some embodiments of the present disclosure, the signal strength parameter is a reference signal receiving power (RSRP) threshold.

In some embodiments of the present disclosure, the processor is further configured to: detect the request for the random access message with repetition or the random access message with repetition in the case that a receiving signal strength at the UE is smaller than the signal strength parameter, or smaller than the signal strength parameter plus the signal strength offset.

In some embodiments of the present disclosure, the non-signal-strength parameter comprises at least one of the following: a time threshold; a distance threshold; a set of geographical areas; a set of logical channels; a set of quality of service (QOS) indicators; a set of random access events; a set of UE capabilities; or a set of UE information availability.

In some embodiments of the present disclosure, the processor is further configured to: detect the request for the random access message with repetition or the random access message with repetition in the case that at least one of the following conditions is met: a propagation delay is larger than or smaller than the time threshold; an estimated timing advance is larger than the time threshold; a distance is larger than the distance threshold; the UE being inside of any of the set of geographical areas; the random access procedure being triggered by a logic channel in the set of logic channels; the random access procedure being triggered by at least one service with a QoS indicator in the set of QoS indicators; the random access procedure being triggered by at least one event in the set of random access events; the UE having at least one capability in the set of UE capabilities; or the UE having available UE information in the set of information availability.

In some embodiments of the present disclosure, the non-signal-strength offset comprises at least one of the following offset: a time offset associated with the time threshold, or a distance offset associated with the distance threshold.

In some embodiments of the present disclosure, the processor is further configured to: detect the request for the random access message with repetition or the random access message with repetition in the case that at least one of the following conditions is met: a propagation delay is larger than or smaller than the time threshold plus the time offset; an estimated timing advance is larger than the time threshold plus the time offset; or a distance is larger than the distance threshold plus the distance offset.

In some embodiments of the present disclosure, the transceiver is further configured to: transmit the configuration information in a system information block or a dedicated signaling.

In some embodiments of the present disclosure, the configuration information includes at most two sets of configuration for supplement uplink (SUL) and normal uplink (NUL) frequencies, respectively.

According to some yet other embodiments of the present disclosure, a method performed by a UE includes: receiving configuration information associated with repetition of a random access message; and determining whether to transmit a request for the random access message with repetition, or determining whether to transmit the random access message with repetition for a random access procedure based on the configuration information, wherein the configuration information at least indicates one of the following: a signal strength parameter and a signal strength offset associated with the signal strength parameter; a non-signal-strength parameter; a non-signal-strength parameter and a non-signal-strength offset associated with the non-signal-strength parameter; or a signal strength parameter and a non-signal-strength parameter.

According to some yet other embodiments of the present disclosure, a method performed by a base station includes: transmitting configuration information associated with repetition of a random access message; and detecting the random access message with repetition or not for a random access procedure; wherein the configuration information at least indicates one of the following: a signal strength parameter and a signal strength offset associated with the signal strength parameter; a non-signal-strength parameter; a non-signal-strength parameter and a non-signal-strength offset associated with the non-signal-strength parameter; or a signal strength parameter and a non-signal-strength parameter.

### BRIEF DESCRIPTION OF THE DRAWINGS

FIGS. 1A-1C respectively illustrate an exemplary NTN network in accordance with some embodiments of the present application.

FIG. 2 illustrates multiple RSRP thresholds for RA resource selection in accordance with some embodiments of the present disclosure.

FIGS. 3A-3D illustrates the determination order of RA type selection and decision on random access message with repetition according to some embodiments of the present disclosure.

FIGS. 4A and 4B illustrate the behavior of the contention resolution timer for random access message with repetition in a 4-step RA procedure according to some embodiments of the present disclosure.

FIG. 5 illustrates an exemplary flow chart for RA access according to some embodiments of the present disclosure.

FIG. 6 illustrates a block diagram of an apparatus according to the embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that all illustrated operations be performed, to achieve desirable results, sometimes one or more operations can be skipped. Further, the drawings can schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

To enhance coverage, 3^{rd} generation group program (3GPP) initiated a study item “Study on NR coverage enhancements” in release (Rel)-17 to identify issues and potential enhancements for radio channels and signals, and enhancements for physical uplink share channel (PUSCH), physical uplink control channel (PUCCH) and Msg3 PUSCH are to be specified in Rel-17 work item phase for coverage enhancements.

Msg3 PUSCH has been identified as one of the bottleneck uplink (UL) channels and Msg3 repetition is considered to solve the coverage problem. Msg3 repetition allows transmission of several successive Msg3 when UE is performing random access (RA) and thus the UL coverage of radio access network (RAN) can be extended. In the 3GPP RAN2 #115 meeting, the discussion of Rel-17 NR coverage enhancement focused on signaling and protocol support of Msg3 repetition.

Besides Msg3 repetition, embodiments of the present disclosure also propose MsgA payload repetition as the random access message with repetition.

In the 4-step contention based random access (CBRA) procedure, when RSRP measurement on DL path loss reference signals is below a configured threshold, UE can transmit its Msg1 over a dedicated set of PRACH resource to indicate its request for Msg3 repetition.

In the 2-step CBRA procedure, if UE determines to request repetition, it transmits a preamble (i.e., preamble part of MsgA) on a set of dedicated PRACH resources. UE may either wait for random access response (i.e., the first part of MsgB) from network with indication of permitting MsgA payload repetition to transmit the repetition afterwards, or directly transmit MsgA payload repetition without waiting for network indication of permitting.

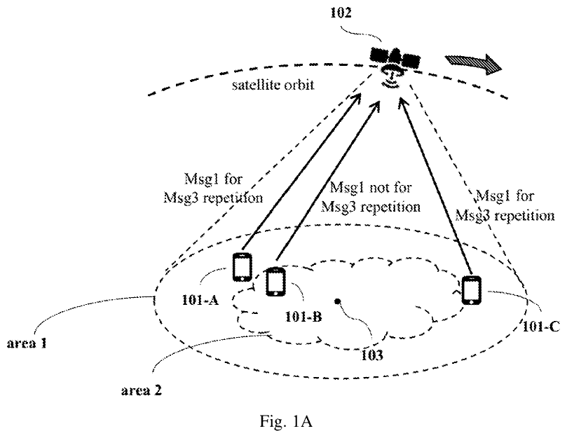

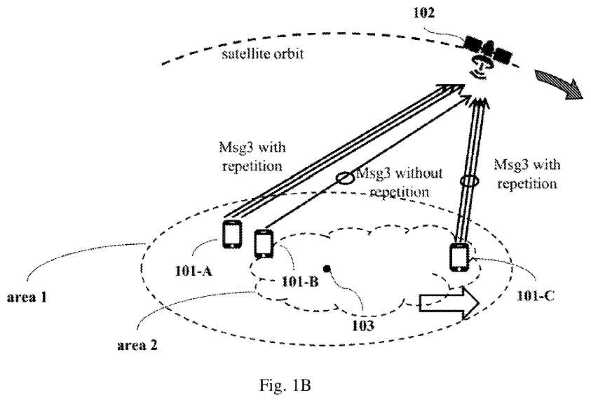

FIGS. 1A-1C respectively illustrate an exemplary scenario of an NTN network during satellite movement in accordance with some embodiments of the present application. Specifically, FIG. 1A illustrates an exemplary scenario of the NTN network in first time, e.g., T1, FIG. 1B illustrates an exemplary scenario of the NTN network in second time, e.g., T2, and FIG. 1C illustrates an exemplary scenario of the NTN network in third time, e.g., T3.

NTN refers to a network, or segment of networks using radio frequency resources on board a satellite. As shown in FIGS. 1A-1C, the wireless communication system includes a plurality of UEs, e.g., UE 101-A, UE 101-B, and UE 101-C. and a BS 102, for example, a satellite BS. Although merely one BS is illustrated in FIGS. 1A-1C for simplicity, it is contemplated that the wireless communication system may include more BSs in some other embodiments of the present application. Similarly, although merely three UEs are illustrated in FIGS. 1A-1C for simplicity, it is contemplated that the wireless communication system may include more UEs in some other embodiments of the present application.

Satellite(s) BS 102 may include low earth orbiting (LEO) satellites orbiting around the earth, medium earth orbiting (MEO) satellites, geostationary earth orbiting (GEO) satellites with fixed location to the earth, as well as highly elliptical orbiting (HEO) satellites. Due to the propagation distance between satellite and ground and the limitation of UE transmission power, the UL coverage issue is even worse in NTN and thus restricts its commercial market. During the discussion for Rel-18 NTN objectives in 3GPP RAN #93 meeting, support of coverage enhancement has been one of the most expected features to be studied in NTN in upcoming Rel-18 (as the 1st non-controversial topic). From this perspective, random access message with repetition as one of the main enhancements will further be used in NTN.

The UE, e.g., UE 101-A, UE 101-B, UE 101-C may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE, e.g., UE 101-A. UE 101-B, UE 101-C may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

The wireless communication system is compatible with any type of network that is capable of sending and receiving wireless communication signals. For example, the wireless communication system is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In TN with low altitude antennas, there is a clear RSRP difference between UEs at the cell center 103, and cell edge (i.e., cell edge effect). However, in an NTN cell, the RSRP difference between UEs at cell center and cell edge is typically insignificant. If the RSRP threshold is used as the only criterion in determining usage of random access message with repetition, it may be difficult for the NTN to configure the RSRP threshold appropriately. A smaller RSRP threshold may prevent most UEs from benefiting coverage enhancement, while a larger RSRP threshold may allow excessive random access message with repetition, which may causing heavier contention on the dedicated PRACH resource for requesting random access message with repetition.

In addition to the smaller RSRP difference, another NTN characteristic, i.e., satellite movement needs to be considered as well.

In 4-step RA, if UE determines to request repetition, it transmits a preamble (i.e. Msg1) on a set of dedicated PRACH resource (e.g. Group B preambles), and receives random access response (i.e. Msg2) from network with indication of permitting Msg3 repetition. Then, UE can transmit Msg3 with repetition. That is, there is at least one satellite-to-ground round trip time (RTT) between requesting (or not requesting) and transmitting (or not transmitting) Msg3 repetition, and during that time period the necessity or availability of Msg3 repetition may vary due to satellite movement.

In 2-step RA, if UE determines to request repetition, it transmits a preamble (i.e. the preamble part of MsgA) on a set of dedicated PRACH resources. The UE may either wait for random access response (i.e., first part of MsgB) from network with indication of permitting MsgA payload repetition to transmit the repetition afterwards, or directly transmit MsgA payload repetition without waiting for network indication of permitting. Similarly, there is also at least one satellite-to-ground RTT between requesting (or not requesting) and transmitting (or not transmitting) MsgA payload repetition, and during that time period the necessity or availability of MsgA payload repetition may vary due to satellite movement and/or UE movement.

For example, in FIGS. 1A-1C, BS 102 is moving in the satellite orbit towards UE 101-C direction, and the coverage area of BS 102 is within the oval marked by “area 1.” The cell center 103 is the cell center of the cell managed by BS 102, and may also be referred to the reference point. The area marked by “area 2” is an area where the RSRP is larger than a RSRP threshold. UEs inside area 2 do not need to perform the RA procedure with RA message with repetition, and the UEs outside area 2 but inside area 1 need to perform the RA procedure with RA message with repetition.

For example, in a RA procedure, e.g., a 4-step CBRA procedure, in FIG. 1A, UE 101-B is inside area 2 and does not need to perform the RA procedure with Msg3 repetition, UE 101-A and UE 101-C are outside area 2 but are inside area 1, and need to perform the RA procedure with Msg3 repetition. Accordingly, UE 101-A and UE 101-C in FIG. 1A transmit Msg1 in time T1, which requests for transmitting Msg3 repetition.

In FIG. 1B, due to the satellite movement and consequent RSRP change, UE 101-B is within area 1 and outside of area 2 at time T2, that is, UE 101-B satisfies the RSRP threshold for requesting Msg3 repetition and needs Msg3 repetition. However, UE 101-B cannot apply Msg3 repetition because it did not request for Msg3 repetition at time T1. On the other hand, UE 101-C is within area 2, and may not need Msg3 repetition, but it has to apply Msg3 repetition because it requested for Msg3 repetition at time T1.

UE 101-A is at the edge of area 1 and out of area 2 at time T2, while in FIG. 1C, due to the satellite movement it may be totally out of area 1. In this case, UE 101-A applies the Msg3 with repetition, but the RA procedure of UE 101-A is probably going to fail. UE 101-A is better to be transited to IDLE mode and try to camp on another cell, instead of transmitting Msg3 repetition. As the same as in FIG. 1B, UE 101-B is within area 1 and outside of area 2, that is, UE 101-B fulfills the RSRP threshold for requesting Msg3 repetition and needs Msg3 repetition, but UE 101-B cannot apply Msg3 repetition because it did not request for Msg3 repetition at time T1. UE 101-C does not need Msg3 repetition, but it has to apply Msg3 repetition because it requested for Msg3 repetition at time T1.

Similar issues may also exist in the 2-step CBRA procedure.

In light of the above, it can be seen that the UE performing random access message with repetition based on the RSRP threshold may not be sufficient for the UE to access to the network successfully.

Embodiments of the present disclosure propose some additional criteria (or parameters, or thresholds) and UE behaviors for requesting the random access message with repetition in 2-step RA procedure or 4-step RA procedure, or transmitting the random access message with repetition without permission from the network in 2-step RA procedure. In 2-step RA procedure, the random access message repeated is MsgA payload, in 4-step RA procedure, the random access message repeated is Msg3.

These additional criteria may be used in the NTN scenario or the TN scenario, and they may be used independently or combined with the RSRP threshold. These additional criteria may be transmitted from the network to the UE in the configuration information via system information broadcasting or dedicated signaling. For example, the configuration information may be transmitted in radio release control (RRC) release message before the UE enters the IDLE/INACTIVE state.

Specifically, these additional criteria at least include:

1. Time criteria, which may include the propagation delay from the UE to the satellite or the ground station, or the UE estimated timing advance. The UE needs to calculate the timing advance for pre-compensation in NTN.

For example, the time criteria may include a time threshold for the propagation delay, TT1. If the propagation delay from the UE to a receiving antenna of a gNB (i.e. the satellite in NTN, such as the BS 102 in FIGS. 1A-1C) is larger than TT1, the UE determines to request for random access message with repetition or transmit the random access message with repetition. The time criteria may include a time threshold for estimated timing advance (TA), TT2. If the estimated TA from the UE to a receiving antenna of the gNB (i.e., the satellite in NTN, such as the BS 102 in FIGS. 1A-1C) is larger than TT2, UE determines to request for random access message with repetition or transmit the random access message with repetition. The time criteria may include a time threshold for the remaining serving time, TT3. If the propagation delay from the UE to its serving gNB is smaller than TT3, the UE determines to request for random access message with repetition or transmit the random access message with repetition. TT3 may be the remaining serving time of the gNB or the receiving antenna of the gNB.

2. Location criteria, which may include the UE distance to a reference point, a set of UE positions, or a set of geographical areas. The reference point may be the cell center (e.g., 103 in FIGS. 1A-1C) or the satellite.

For instance, the location criteria may include a distance threshold D1. If the distance from the UE to a reference point is larger than D1, the UE determines to request for random access message with repetition. The reference point may be a receiving antenna of the gNB, a cell center, or a location indicated by network.

The location criteria may include a set of locations L1 or a set of geographical areas A1. If the UE is at a location in L1 or within an area of A1, the UE determines to request for random access message with repetition. For example, when the UE is within area 1 and outside of area 2 in FIGS. 1A-1C, it may determine to request for random access message with repetition.

3. Service criteria, which may include quality of service (QOS) requirements of service or logical channels (LCH) that triggers the RA procedure.

For example, the logical channel may include a set of logic channels LH1. If the RA procedure of the UE is triggered by a logic channel of the logical channel set LH1, the UE determines to request for random access message with repetition.

The QoS requirement of service may include a set of QoS indicators Q1. If the RA procedure of the UE is triggered by a service with a QoS indicator in Q1, the UE determines to request for random access message with repetition.

4. RA event criteria, which may include each of all events that can trigger the random access procedure (e.g. initial access, RRC reestablish, RRC resume, synchronization, handover (HO), beam failure report (BFR) request for scheduling request (SR) resource, or other system information).

The RA event may include a set of events E1. If the RA procedure of the UE is triggered by an event of E1, the UE determines to request for random access message with repetition.

5. Additional applying conditions, which may include UE capabilities (such as timing advance pre-compensation or positioning or type/high-power UE) or information availability (e.g. positioning information or ephemeris).

The UE capabilities may include a set of UE capabilities C1. If the UE is with or without at least one of the capabilities of C1, the UE determines to request for random access message with repetition.

The UE information availability may include a set of UE information availability I1. If the UE is with or without at least one of the information of I1, the UE determines to request for random access message with repetition.

Based on the above exemplary criteria, exemplary implementation in 3GPP specifications for random access procedure initialization, e.g., in section of Random Access Procedure in TS38. 321 may be presented as follows:

RRC configures the following parameters for the Random Access procedure:
msg3rep-Time-threshold: a time threshold for requesting Msg3 repetition.
msg3rep-Distance-threshold: a distance threshold for requesting Msg3 repetition.
msg3rep-Location: a set of locations for requesting Msg3 repetition.
msg3rep-Area: a set of areas for requesting Msg3 repetition.
msg3rep-LCH: a set of LCHs for requesting Msg3 repetition.
msg3rep-5QI: a set of 5QIs for requesting Msg3 repetition.
msg3rep-Event: a set of RA events for requesting Msg3 repetition.
msg3rep-Capability: a set of UE capabilities for requesting Msg3 repetition.
msg3rep-Availability: a set of UE information availability for requesting Msg3 repetition.

When the Random Access procedure is initiated on a Serving Cell, the MAC entity shall:
1> if the RTT_{UE-specific} is larger than msg3rep-Time-threshold.
   2> set the MSG3_REP to Enabled.
1> if the TA_{UE-specific} is larger than msg3rep-Time-threshold.
   2> set the MSG3_REP to Enabled.
1> if the RTT_{UE-gNB} is smaller than msg3rep-Time-threshold.
   2> set the MSG3_REP to Enabled.
1> if the Distance_{UE-ref} is larger than msg3rep-Distance-threshold.
   2> set the MSG3_REP to Enabled.
1> if the UE_Location is in msg3rep-Location/msg3rep-Area.
   2> set the MSG3_REP to Enabled.
1> if the LCH that triggers the RA procedure is in msg3rep-LCH.
   2> set the MSG3_REP to Enabled.
1> if the 5QI of the service that triggers the RA procedure is in msg3rep-5QI.
   2> set the MSG3_REP to Enabled.
1> if the RA event that triggers the RA procedure is in msg3rep-Event.
   2> set the MSG3_REP to Enabled.
1> if the UE is with UE capability in msg3rep-Capability.
   2> set the MSG3_REP to Enabled.
1> if the UE is with available information in msg3rep-Availability.
   2> set the MSG3_REP to Enabled.

It should be noted that the expressions “Msg3 repetition,” “MSG3_REP,” “msg3rep” or the like in the present disclosure are examples of the random access message with repetition, but not limited to the Msg3 in the 4-step RA procedure. Other messages such as the payload of MsgA or the like also apply here.

Some criteria may include an offset. For example, corresponding offsets may be applied to at least one of the criteria for requesting random access message with repetition, and the offsets may include at least one of the following:
1. A signal strength offset associated with a RSRP threshold.
2. A time offset associated with a time threshold.
   For example, the time criteria may include a time threshold TT1 and a time offset associated with the time threshold offset_{TT1}. If the propagation delay from the UE to a receiving antenna of a gNB (i.e., the satellite in NTN, such as the BS 102 in FIGS. 1A-1C) is larger than TT1 plus the offset_{TT1}, the UE determines to request for random access message with repetition or transmit the random access message with repetition. The time criteria may include a time threshold TT2 and a time offset associated with the time threshold offset_{TT2}. If the estimated timing advance from the UE to a receiving antenna of a gNB (i.e., the satellite in NTN, such as the BS 102 in FIGS. 1A-1C) is larger than T2 plus the offset_{TT2}, the UE determines to request for random access message with repetition or transmit the random access message with repetition. The time criteria may include a time threshold TT3 and a time offset associated with the time threshold offset_{TT3}. If the propagation delay from the UE to its serving gNB is smaller than TT3 plus the offset_{TT3}, the UE determines to request for random access message with repetition or transmit the random access message with repetition. TT3 may be the remaining serving time of the gNB or the receiving antenna of the gNB.
3. A distance offset associated with a distance threshold.
   For instance, the location criteria may include a distance threshold D1 and a distance offset associated with the distance threshold offset_{D1}. If the distance from the UE to a reference point is larger than D1 plus the offset_{D1}, the UE determines to request for random access message with repetition.

Based on the above exemplary criteria with offsets, exemplary implementation in 3GPP specifications for random access procedure initialization, e.g., in section of Random Access Procedure in TS38. 321 may be is as follows: RRC configures the following parameters for the Random Access procedure:
msg3rep-RSRP-offset: a RSRP offset applied to msg3rep-RSRP-Threshold for requesting Msg3 repetition.
msg3rep-Time-offset: a time offset applied to msg3rep-Time-Threshold for requesting Msg3 repetition.
msg3rep-Distance-offset: a distance offset applied to msg3rep-Distance-Threshold for requesting Msg3 repetition.

When the Random Access procedure is initiated on a Serving Cell, the MAC entity shall:
1> if the RSRP of UE is larger than msg3rep-RSRP-threshold plus msg3rep-RSRP-offset.
   2> set the MSG3_REP to Enabled.
1> if the RTT_{UE-specific} is larger than msg3rep-Time-threshold plus msg3rep-Time-offset.
   2> set the MSG3_REP to Enabled.
1> if the TA_{UE-specific} is larger than msg3rep-Time-threshold plus msg3rep-Time-offset.
   2> set the MSG3_REP to Enabled.
1> if the Distance_{UE-ref} is larger than msg3rep-Distance-threshold plus msg3rep-Distance-offset.
   2> set the MSG3_REP to Enabled.

After receiving the configuration information including the criteria, the UE determines whether to request for random access message with repetition based on the configuration or transmit the random access message with repetition without requesting.

Specifically, the UE may perform the determination based on the one of the following parameters, which may be configured in the configuration from the BS:
1. the RSRP threshold and the offset associated with the RSRP threshold;
2. at least one of the above criteria;
3. the RSRP threshold and at least one of the above criteria;
4. at least one of the above criteria and the offset associated with the criteria;
5. the RSRP threshold, the offset associated with the RSRP threshold, and at least one of the above criteria;
6. the RSRP threshold, at least one of the above criteria, and the offset associated with the criteria; or
7. the RSRP threshold, the offset associated with the RSRP threshold, at least one of the above criteria, and the offset associated with the criteria.

For example, in some embodiments of the present disclosure, the UE may determine to request for random access message with repetition based on the configuration information, e.g., to request for Msg3 repetition in 4-step RA procedure or for MsgA payload in 2-step RA procedure. In some other embodiments of the present disclosure, the UE may determine to transmit the random access message with repetition without request, e.g., to transmit the MsgA payload in 2-step RA procedure.

In some other embodiments, an offset or a stop condition may be considered for the UE to perform such determination, e.g., determination on whether to request for random access message with repetition or not. The offset may be a positive or negative value applied to at least one of the above parameters, e.g., the RSRP threshold, and/or other thresholds if the satellite is leaving/approaching the UE.

In an embodiment, the configuration information may include a signal strength offset Offset1 associated with a RSRP threshold. The UE applies Offset1 to the RSRP threshold based on its relative movement to the receiving antenna of a gNB (e.g., the satellite in NTN, e.g. the BS 102 in FIGS. 1A-1C). When the receiving antenna of the gNB is leaving the UE, if the RSRP at the UE is smaller than the RSRP threshold plus Offset1 or the RSRP at the UE minus Offset1 is smaller than the RSRP threshold, the UE determines to request for random access message with repetition. When the receiving antenna of the gNB is approaching the UE, if the RSRP at the UE is smaller than the RSRP threshold minus Offset1, or the RSRP at the UE plus Offset1 is smaller than the RSRP threshold, the UE determines to request for random access message with repetition.

Although some embodiments of the present application are illustrated only with solutions on how to determine to request for random access message with repetition based on the configuration information, or only with solutions on how to determine to transmit the random access message with repetition without request based on the configuration information, persons skilled in the art should well know that the illustrated solutions can also be adaptive to the other determination on random access message with repetition. For example, the above determination solution can also be applied to determine whether to transmit the random access message with repetition.

In another embodiment, the configuration information may include a time offset Offset2 associated with a time threshold TT1. The UE applies Offset2 to T1 based on its relative movement to the receiving antenna of the gNB (e.g. the satellite in NTN, e.g. the BS 102 in FIGS. 1A-1C). When the receiving antenna of the gNB is leaving the UE, if the propagation delay from the UE to the receiving antenna of the gNB is smaller than TT1 plus Offset2 or the propagation delay from the UE to the receiving antenna of the gNB minus Offset2 is smaller than TT1, the UE determines to request for random access message with repetition. When the receiving antenna of the gNB is approaching the UE, if the propagation delay from the UE to the receiving antenna of the gNB is smaller than TT1 minus Offset2 or the propagation delay from the UE to the receiving antenna of the gNB plus Offset2 is smaller than TT1, the UE determines to request for random access message with repetition.

In yet another embodiment, the configuration information may include a time offset Offset3 associated with a time threshold TT2. The UE applies Offset3 to TT2 based on its relative movement to the receiving antenna of the gNB (e.g. the satellite in NTN, e.g. the BS 102 in FIGS. 1A-1C). When the receiving antenna of the gNB is leaving the UE, if the estimated timing advance from the UE to the receiving antenna of the gNB is smaller than TT2 plus Offset3, or the propagation delay from the UE to the receiving antenna of the gNB minus Offset3 is smaller than TT2, the UE determines to request for random access message with repetition. When the receiving antenna of the gNB is approaching the UE, if the estimated timing advance from the UE to the receiving antenna of the gNB is smaller than TT2 minus Offset3 or the propagation delay from the UE to the receiving antenna of the gNB plus Offset3 is smaller than TT2, the UE determines to request for random access message with repetition.

In still another embodiment, the configuration information may include a distance offset Offset4 associated with a distance threshold D1. The UE applies Offset4 to D1 based on its relative movement to the receiving antenna of the gNB (e.g. the satellite in NTN, e.g. the BS 102 in FIGS. 1A-1C). When the receiving antenna of the gNB is leaving the UE, if the between the UE and the receiving antenna of the gNB is smaller than D1 plus Offset4 or the propagation delay from the UE to the receiving antenna of the gNB minus Offset4 is smaller than D1, the UE determines to request for random access message with repetition. When the receiving antenna of the gNB is approaching the UE, if the between the UE and the receiving antenna of the gNB is smaller than D1 minus Offset4 or the propagation delay from the UE to the receiving antenna of the gNB plus Offset4 is smaller than D1, the UE determines to request for random access message with repetition.

In some other embodiments, a stop condition may be applied to prohibit transmitting random access message with repetition or prohibit the request for random access message with repetition if the remaining service time of the satellite to the UE is under a time threshold, e.g. the time threshold may be one RTT or two RTTs. That is, the UE is soon to be out of service of the BS, and then it is not necessary to perform the RACH procedure towards the cell.

After the UE receives the configuration, the UE may determine to request for random access message with repetition or transmit the random access message with repetition without requesting when at least one of the following condition is met:
1. the configuration information includes a signal strength offset, and the receiving signal strength at the UE is offset smaller than a RSRP threshold, i.e. the receiving signal strength at the UE plus the signal strength offset is smaller than a RSRP threshold, or the receiving signal strength at the UE is smaller than a RSRP threshold plus the signal strength offset.
2. the configuration information includes a time threshold (and/or a time offset associated with the time threshold), and the propagation delay from the UE to a receiving antenna of the gNB (e.g. the satellite in NTN) is larger than the time threshold, with or without the time offset applied.
3. the configuration information includes a time threshold (and/or a time offset associated with the time threshold), and the estimated timing advance from the UE to a receiving antenna of the gNB is larger than the time threshold, with or without the time offset applied.
4. the configuration information includes a time threshold (and/or a time offset associated with the time threshold), and the propagation delay from the UE to a gNB (i.e. the ground station in NTN) is smaller than the time threshold, with or without the time offset applied.
5. the configuration information includes a distance threshold (and/or a distance offset associated with the distance threshold), and the distance from the UE to a reference point is larger than the distance threshold, with or without the distance offset applied. The reference point could be a receiving antenna of the gNB, a cell center, or a location indicated by network.
6. the configuration information includes a set of locations or areas, and the UE is at a location or within an area in the set of locations or areas.
7. the configuration information includes a set of logic channels, and the RA procedure of the UE is triggered by a logic channel in the set of logic channels.
8. the configuration information includes a set of QoS indicators, and the RA procedure of the UE is triggered by a service with a QoS indicator in the set of QoS indicators.
9. the configuration information includes a set of events, and the RA procedure of the UE is triggered by an event in the set of events that trigger the RA.
10. the configuration information includes a set of UE capabilities, and the UE is with a capability in the set of UE capabilities.
11. the configuration information includes a set of UE information availability, and the UE is with available UE information in the set of information availability.
12. A combination of at least one of above criteria and the RSRP criterion.

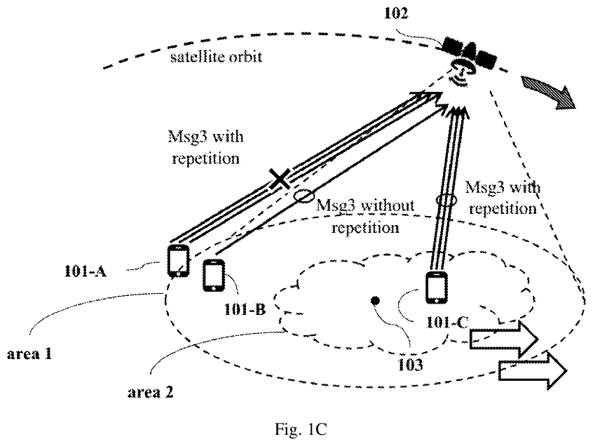

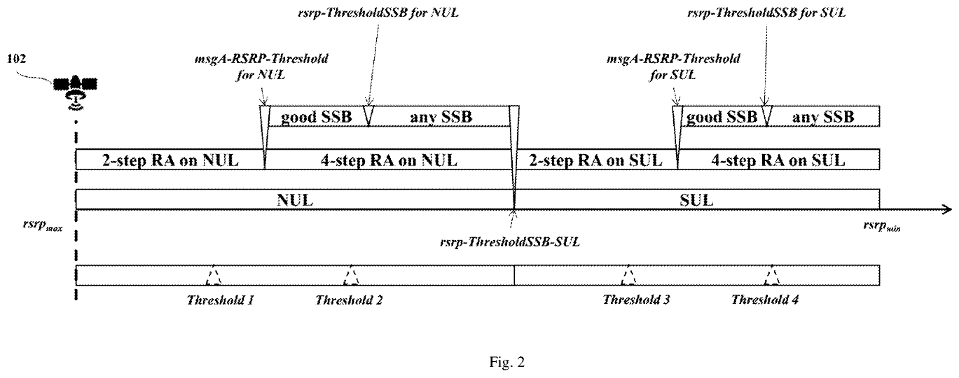

FIG. 2 illustrates multiple RSRP thresholds for RA resource selection in accordance with some embodiments of the present disclosure.

In FIG. 2, the horizontal axis represents the value of RSRP, the origin of the horizontal axis has the largest value of RSRP, which is the closest position to the BS 102, and is marked by “rsrpₘₐₓ,” and the RSRP becomes smaller along the horizontal axis, and the minimum value of RSRP is marked by “rsrpₘᵢₙ.”

The threshold marked by “rsrp-ThresholdSSB-SUL” is used to determine whether to perform RACH on normal uplink (NUL) or supplementary uplink (SUL). Specifically, if the RSRP is within the range from “rsrpₘₐₓ” to “rsrp-ThresholdSSB-SUL”, the UE performs RACH on NUL; and if the RSRP is within the range from “rsrp-ThresholdSSB-SUL” to “rsrpₘᵢₙ”, the UE performs RACH on SUL.

Within the range from “rsrpₘₐₓ” to “rsrp-ThresholdSSB-SUL,” the threshold marked by “msgA-RSRP-Threshold for NUL” is used to determine whether to perform 2-step RA procedure or 4-step RA procedure on NUL. Specifically, if the RSRP is within the range from “rsrpₘₐₓ” to “msgA-RSRP-Threshold for NUL”, the UE performs 2-step RA procedure on NUL; and if not, the UE performs 4-step RA procedure on NUL.

Within the range from “msgA-RSRP-Threshold for NUL” to “rsrp-ThresholdSSB-SUL,” the threshold marked by “rsrp-ThresholdSSB for NUL” is used to determine whether to select good synchronization signal and physical broadcast channel block (SSB) or any SSB associated RACH resource. Specifically, if the RSRP is within the range from “msgA-RSRP-Threshold for NUL” to “rsrp-ThresholdSSB for SUL”, the UE selects good SSB associated RACH resource; and if not, the UE selects any SSB associated RACH resource.

Within the range from “rsrp-ThresholdSSB-SUL” to “rsrpₘᵢₙ,” the threshold marked by “msgA-RSRP-Threshold for SUL” is used to determine whether to perform 2-step RA procedure or 4-step RA procedure on SUL. Specifically, if the RSRP is within the range from “rsrp-ThresholdSSB-SUL” to “msgA-RSRP-Threshold for SUL”, the UE performs 2-step RA procedure on SUL; and if not, the UE performs 4-step RA procedure on SUL.

Within the range from “msgA-RSRP-Threshold for SUL” to “rsrpₘᵢₙ,” the threshold marked by “rsrp-ThresholdSSB for SUL” is used to determine whether to select good SSB or any SSB associated RACH resource. Specifically, if the RSRP is within the range from “msgA-RSRP-Threshold for SUL” to “rsrp-ThresholdSSB for SUL”, the UE selects good SSB associated RACH resource; and if not, the UE selects any SSB associated RACH resource.

In FIG. 2, the illustrated thresholds, i.e., rsrp-ThresholdSSB-SUL, msgA-RSRP-Threshold for NUL, rsrp-ThresholdSSB for NUL, msgA-RSRP-Threshold for SUL, and rsrp-ThresholdSSB for SUL do not overlap with each other. However, considering that random access message with repetition can be used in NUL or SUL, in 2-step RA or 4-step RA, and in good SSB or any SSB, the thresholds for random access message with repetition can be configured anywhere in the possible value ranges. For example, in FIG. 2, the embodiments of the present disclosure propose four thresholds for random access message with repetition, which are respectively marked by “Threshold 1,” “Threshold 2,” “Threshold 3,” and “Threshold 4.” Furthermore, the random access message with repetition is made before Msg1 or MsgA transmission (the same as determinations (or decisions) on SUL or NUL, 2 or 4-step RA, good or any SSB) as well.

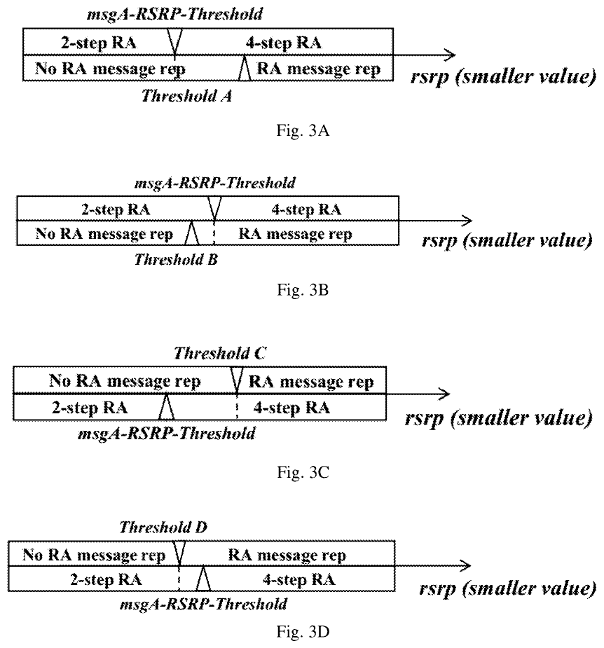

FIGS. 3A-3D illustrate the determination order of RA type selection and decision on random access message with repetition according to some embodiments of the present disclosure.

In FIGS. 3A-3D, the threshold “msgA-RSRP-Threshold” may be any one of “msgA-RSRP-Threshold for NUL” or “msgA-RSRP-Threshold for SUL”, and is used to determine whether to perform 2-step RA procedure or 4-step RA procedure on NUL or SUL. “Threshold A,” “Threshold B,” “Threshold C,” and “Threshold D” all refer to the threshold for random access message with repetition. The RSRP value becomes smaller along the horizontal axis.

SUL and NUL have different requirements on random access message with repetition and random access message with repetition needs to use specific preamble resources in a carrier. Therefore, the SUL or NUL decision should be made before the decision on random access message with repetition. Meanwhile, there is no restriction on using random access message with repetition on SSB, so that the good or any SSB decision can be made before or after the decision on random access message with repetition.

Regarding the determination order of RA type selection and decision on random access message with repetition, in some embodiments, for example, in FIG. 3A and FIG. 3B, the RA type selection is performed before the decision on random access message with repetition for UEs in a cell that enables random access message with repetition. The decision of requesting random access message with repetition can be determined based on the result of RA type selection.

Specifically, when RA type selection is performed before the decision of requesting random access message with repetition for the UEs in a cell that enables random access message with repetition, the UE may take the following actions:
If 2-step RA is selected (it is supposed that 2-step RA also supports random access message with repetition)
   If only the RSRP criterion is used for decision of requesting random access message with repetition.
      If Threshold A is not larger than msgA-RSRP-Threshold, UE considers request for random access message with repetition as not fulfilled. (This scenario is shown in FIG. 3A)
      Else (Threshold B is larger than msgA-RSRP-Threshold) UE may perform decision of requesting random access message with repetition. (This scenario is shown in FIG. 3B)
   Else (other criteria than RSRP is used) UE may perform decision of requesting random access message with repetition.
Else (4-step RA is selected)
   If only the RSRP criterion is used for decision of requesting random access message with repetition
      If Threshold A is not larger than msgA-RSRP-Threshold, UE may perform decision of requesting random access message with repetition. (This scenario is shown in FIG. 3A)
      Else (Threshold B is larger than msgA-RSRP-Threshold) UE considers random access message with repetition as fulfilled. (This scenario is shown in FIG. 3B)
   Else (other criteria than RSRP is used) UE may perform decision of requesting random access message with repetition.

In some other embodiments, for example, in FIG. 3C and FIG. 3D, the decision of requesting random access message with repetition is performed before the RA type selection for the UEs in a cell that enables random access message with repetition. The RA type selection could be determined based on the result of decision of requesting random access message with repetition.

Specifically, when RA type selection is performed after the decision of requesting random access message with repetition for the UEs in a cell that enables random access message with repetition, the UE may take the following actions:
If random access message with repetition is decided to be requested
   If the RSRP criterion is used for decision of requesting random access message with repetition.
      If Threshold C is not larger than msgA-RSRP-Threshold, the UE considers 4-step RA as fulfilled. (This scenario is shown in FIG. 3C).
      Else (Threshold D is larger than msgA-RSRP-Threshold) the UE may perform RA type selection. (This scenario is shown in FIG. 3D)
      “If 2-step RA is selected and 2-step RA does not support, the UE considers request for random access message with repetition as not fulfilled.
   Else (RSRP criterion is not used) the UE may perform RA type selection.
Else (random access message with repetition is decided not to be requested)
   If the RSRP criterion is used for decision of requesting random access message with repetition.
      If Threshold C is not larger than msgA-RSRP-Threshold, the UE may perform RA type selection. (This scenario is shown in FIG. 3C)
      Else (Threshold D is larger than msgA-RSRP-Threshold) the UE considers 2-step RA as fulfilled. (This scenario is shown in FIG. 3D)
   Else (RSRP criterion is not used) the UE may perform RA type selection.

In some other embodiments, if 2-step RA is selected, and random access message with repetition is configured, the UE may transmit the MsgA payload when the RSRP threshold is satisfied.

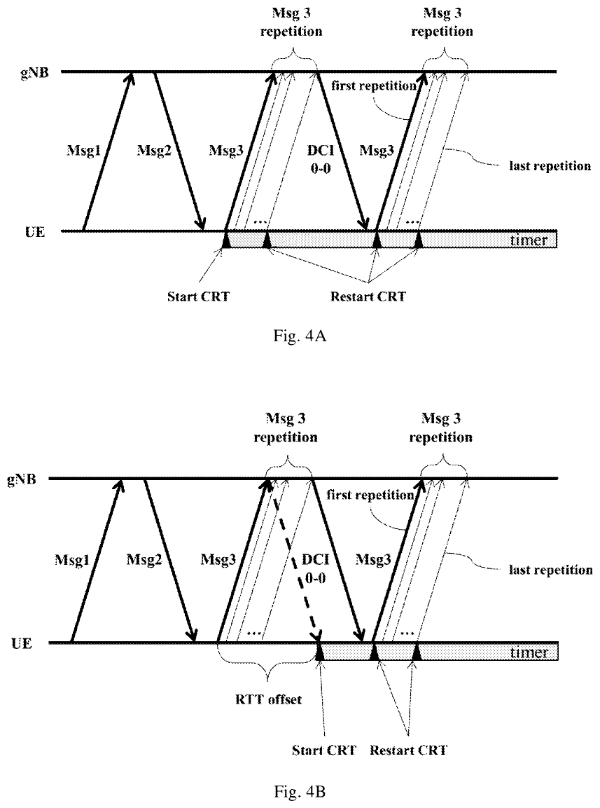

FIGS. 4A and 4B illustrate the behavior of the contention resolution timer (which may be referred to as ContentionResolutionTimer) for random access message with repetition in a 4-step RA procedure according to some embodiments of the present disclosure.

In FIG. 4A, the UE transmits a preamble (i.e. Msg1) on a set of dedicated PRACH resource (e.g. Group B preambles), and receives random access response (i.e. Msg2) from network with indication of permitting Msg3 repetition. Then the UE transmits Msg3 with repetition. In FIG. 4A, the contention resolution timer is started immediately upon the first Msg3 transmission. When gNB transmits a non-acknowledgement (NACK) to the UE, the UE may retransmit the Msg3 transmission, and restart the contention resolution timer upon the Msg3 retransmission. The contention resolution timer is running when Msg3 repetition occurs.

In FIG. 4B, due to the large propagation delay in NTN, a time offset equal to UE-gNB RTT is applied to the start of the contention resolution timer to avoid unnecessary monitoring, because no contention resolution configuration will arrive within the RTT. The contention resolution timer behaviors for Msg3 repetition with delayed start are as follows.

For NTN with a RTT offset applied to the start of the contention resolution timer, a random access message with repetition may occur when the contention resolution timer is either running or not. A random access message with repetition will not start the contention resolution timer if it occurs within the RTT offset (i.e. the contention resolution timer is not running), and will restart the contention resolution timer (at the last repetition) if it occurs after the RTT offset (i.e., the contention resolution timer is running). The UE may apply the following logic:
If a time offset is applied to the start of the contention resolution timer
   If a transmission of random access message with repetition occurs when the contention resolution timer is not running, the contention resolution timer is not started.
   Else (a transmission of random access message with repetition occurs when the contention resolution timer is running) the contention resolution timer can be restarted if the transmission of random access message with repetition is the last repetition or any repetition in a series of multiple repetitions.

In other words, a time offset is applied to the start of the contention resolution timer. When the contention resolution timer is not running, and the UE determines to request for random access message with repetition, the transmission of random access message with repetition does not start the contention resolution timer at this time. In the case that the contention resolution timer is running, and the UE determines to request for random access message with repetition, the UE may restart the contention resolution timer at this time.

Based on the above exemplary solutions, exemplary possible implementation in 3GPP specifications for contention resolution, e.g., in TS38.321 is as follows:

Once Msg3 is transmitted the MAC entity shall:
1> if the Msg3 is a repeated Msg3 for Msg3 repetition
   2> if the ra-ContentionResolutionTimer is running
      3>restart the ra-ContentionResolutionTimer in the first symbol after the end of the last repeated Msg3 transmission

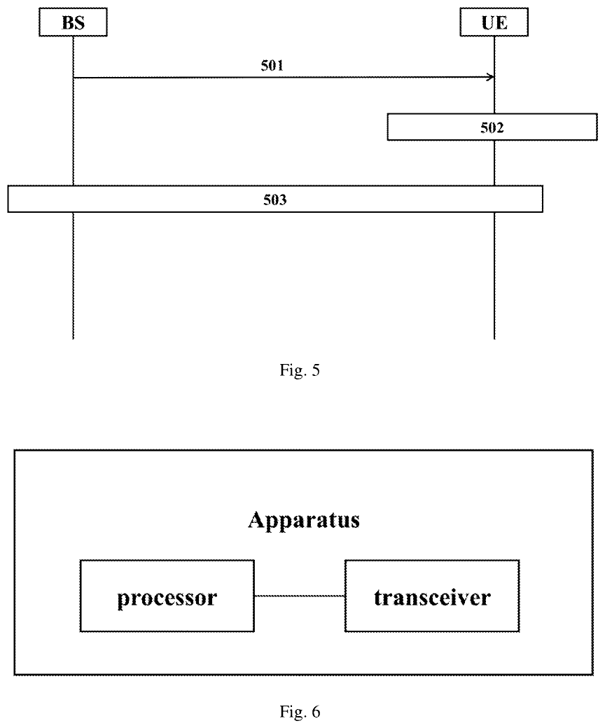

FIG. 5 illustrates an exemplary flow chart for RA access according to some embodiments of the present disclosure.

In step 501, the BS transmits configuration information associated with repetition of a random access message to the UE. The configuration information at least indicates one of the following: a signal strength parameter and a signal strength offset associated with the signal strength parameter; a non-signal-strength parameter; a non-signal-strength parameter and a non-signal-strength offset associated with the non-signal-strength parameter; or a signal strength parameter and a non-signal-strength parameter. In some embodiments, the signal strength parameter is a RSRP threshold. For example, “Threshold A” as shown in FIG. 3A.

In step 502, the UE determines whether to transmit a request for the random access message with repetition or determines whether to transmit the random access message with repetition for a random access procedure based on the configuration information. Correspondingly, at BS side, the BS detects a request for the random access message with repetition, or the random access message with repetition for a random access procedure.

In step 503, the UE performs a RA procedure. In some embodiments, the random access message is Msg3 in a 4-step random access procedure or MsgA payload for 2-step random access procedure.

In some embodiments, the UE determines to transmit the request for the random access message with repetition or transmit the random access message with repetition in the case that a receiving signal strength at the UE is smaller than the signal strength parameter, or smaller than the signal strength parameter plus the signal strength offset.

In some embodiments, the non-signal-strength parameter comprises at least one of the following: a time threshold; a distance threshold; a set of geographical areas; a set of logical channels; a set of QoS indicators; a set of random access events; a set of UE capabilities; or a set of UE information availability.

In some embodiments, the UE determines to transmit the request for the random access message with repetition or transmit the random access message with repetition in the case that at least one of the following conditions is met: a propagation delay is larger than or smaller than the time threshold; an estimated timing advance is larger than the time threshold; a distance is larger than the distance threshold; the UE being inside of any of the set of geographical areas; a random access procedure being triggered by a logic channel in the set of logic channels; the random access procedure being triggered by at least one service with a QoS indicator in the set of QoS indicators; the random access procedure being triggered by at least one event in the set of random access events; the UE having at least one capability in the set of UE capabilities; or the UE having available UE information in the set of information availability.

In some embodiments, the non-signal-strength offset comprises at least one of the following offset: a time offset associated with the time threshold, or a distance offset associated with the distance threshold.

In some embodiments, the UE determines to transmit the request for the random access message with repetition or transmit the random access message with repetition in the case that at least one of the following conditions is met: a propagation delay is larger than or smaller than the time threshold plus the time offset; an estimated timing advance is larger than the time threshold plus the time offset; or a distance is larger than the distance threshold plus the distance offset.

In some embodiments, the UE receives the configuration information in a system information block or a dedicated signaling.

In some embodiments, the UE determines a type of the random access procedure before determining whether to transmit the random access message with repetition; or determines a type of the random access procedure after determining whether to transmit the random access message with repetition. For example, in FIGS. 3A and 3B, the UE determines the RA type before the decision of requesting random access message with repetition. In FIGS. 3C and 3D, the UE determines the RA type after determining whether to transmit the random access message with repetition.

In some embodiments, in the case of determining to transmit the random access message with repetition and a time offset being applied at a start of a contention resolution timer, the UE does not start the contention resolution timer not running in response to a transmission of random access message occurring and the contention resolution timer.

In some embodiments, in the case of determining to transmit the random access message with repetition and a time offset being applied at a start of a contention resolution timer, the UE restarts the contention resolution timer being running in response to a transmission of random access message with repetition occurring.

In some embodiments, the configuration information includes at most two sets of configuration for SUL and NUL frequencies, respectively.

FIG. 6 illustrates a block diagram of an apparatus according to the embodiments of the present disclosure.

The apparatus may be or include at least a part of a BS (e.g., BS 102), a UE (for example, UE 101-A, UE 101-B, UE 101-C), or other device with similar functionality.

The apparatus may include a transmitter, a processor, and a transceiver coupled with the processor. In some embodiments, the transmitter and the receiver can be combined into a transceiver. The processor is configured to perform any of the methods described in the present disclosure, for example, the method described with respect to FIG. 5. For example, when the apparatus is implemented as a UE, the receiver may receive configuration information associated with repetition of a random access message. The processor may determine whether to transmit a request for the random access message with repetition, or determine whether to transmit the random access message with repetition for a random access procedure based on the configuration information, wherein the configuration information at least indicates one of the following: a signal strength parameter and a signal strength offset associated with the signal strength parameter; a non-signal-strength parameter; a non-signal-strength parameter and a non-signal-strength offset associated with the non-signal-strength parameter; or a signal strength parameter and a non-signal-strength parameter.

When the apparatus is implemented as a BS, the transmitter may transmit configuration information associated with repetition of a random access message, and the processor may detect a request for the random access message with repetition; or detect the random access message with repetition or not for a random access procedure, wherein the configuration information at least indicates one of the following: a signal strength parameter and a signal strength offset associated with the signal strength parameter; a non-signal-strength parameter; a non-signal-strength parameter and a non-signal-strength offset associated with the non-signal-strength parameter; or a signal strength parameter and a non-signal-strength parameter.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1. A user equipment (UE) for wireless communication, comprising:
at least one memory; and
at least one processor coupled with the at least one memory and configured to cause the UE to:
receive configuration information associated with repetition of a random access message; and
determine whether to transmit a request for the random access message with repetition or determine whether to transmit the random access message with repetition for a random access procedure based on the configuration information, wherein the configuration information at least indicates one of:
a signal strength parameter and a signal strength offset associated with the signal strength parameter;
a non-signal-strength parameter;
a non-signal-strength parameter and a non-signal-strength offset associated with the non-signal-strength parameter; or
a signal strength parameter and a non-signal-strength parameter.

2. The UE of claim 1, wherein the random access message comprises one or more of Msg3 in a 4-step random access procedure or MsgA payload for 2-step random access procedure.

3. The UE of claim 1, wherein the at least one processor is further configured to cause the UE to:
determine to transmit the request for the random access message with repetition or transmit the random access message with repetition in a case that a receiving signal strength at the UE is one or more of smaller than the signal strength parameter, or smaller than the signal strength parameter plus the signal strength offset.

4. The UE of claim 1, wherein the non-signal-strength parameter comprises at least one of:
a time threshold;
a distance threshold;
a set of geographical areas;
a set of logical channels;
a set of quality of service (QOS) indicators;
a set of random access events;
a set of UE capabilities; or
a set of UE information availability.

5. The UE of claim 4, wherein the at least one processor is further configured to cause the UE to:
determine to transmit the request for the random access message with repetition or transmit the random access message with repetition in a case that at least one of:
a propagation delay is larger than or smaller than the time threshold;
an estimated timing advance is larger than the time threshold;
a distance is larger than the distance threshold;
the UE being inside of any of the set of geographical areas;
a random access procedure being triggered by a logical channel in the set of logical channels;
the random access procedure being triggered by at least one service with a QoS indicator in the set of QoS indicators;
the random access procedure being triggered by at least one event in the set of random access events;
the UE having at least one capability in the set of UE capabilities; or
the UE having available UE information in the set of UE information availability.

6. The UE of claim 4, wherein the non-signal-strength offset comprises at least one of:
a time offset associated with the time threshold, or
a distance offset associated with the distance threshold.

7. The UE of claim 6, wherein the at least one processor is further configured to cause the UE to:
determine to one or more of transmit the request for the random access message with repetition or transmit the random access message with repetition in a case that at least one of:
a propagation delay is larger than or smaller than the time threshold plus the time offset;
an estimated timing advance is larger than the time threshold plus the time offset; or
a distance is larger than the distance threshold plus the distance offset.

8. The UE of claim 1, wherein the at least one processor is further configured to cause the UE to one or more of:
determine a type of the random access procedure before determining whether to transmit the random access message with repetition; or
determine a type of the random access procedure after determining whether to transmit the random access message with repetition.

9. The UE of claim 1, wherein in a case of determining to transmit a request for the random access message with repetition or transmit the random access message with repetition and a time offset being applied at a start of a contention resolution timer, the at least one processor is further configured to cause the UE to:
not start the contention resolution timer in response to a transmission of random access message with repetition occurring and the contention resolution timer.

10. A base station (BS) for wireless communication, comprising:
at least one memory; and
at least one processor coupled with the at least one memory and configured to cause the BS to:
transmit, to a user equipment (UE), configuration information associated with repetition of a random access message;
detect a request for the random access message with repetition; or
detect the random access message with repetition or not for a random access procedure;
wherein the configuration information at least indicates one of:
a signal strength parameter and a signal strength offset associated with the signal strength parameter;
a non-signal-strength parameter;
a non-signal-strength parameter and a non-signal-strength offset associated with the non-signal-strength parameter; or
a signal strength parameter and a non-signal-strength parameter.

11. The BS of claim 10, wherein the random access message comprises one or more of Msg3 in a 4-step random access procedure or MsgA payload for 2-step random access procedure.

12. The BS of claim 10, wherein the at least one processor is further configured to cause the BS to:
detect the request for the random access message with repetition or the random access message with repetition in a case that a receiving signal strength at the UE is smaller than the signal strength parameter, or smaller than the signal strength parameter plus the signal strength offset.

13. The BS of claim 10, wherein the non-signal-strength parameter comprises at least one of:
a time threshold;
a distance threshold;
a set of geographical areas;
a set of logical channels;
a set of quality of service (QOS) indicators;
a set of random access events;
a set of UE capabilities; or
a set of UE information availability.

14. The BS of claim 13, wherein the at least one processor is further configured to cause the BS to:
detect one or more of the request for the random access message with repetition or the random access message with repetition in a case that at least one of:
a propagation delay is larger than or smaller than the time threshold;
an estimated timing advance is larger than the time threshold;
a distance is larger than the distance threshold;
the UE being inside of any of the set of geographical areas;
the random access procedure being triggered by a logical channel in the set of logical channels;
the random access procedure being triggered by at least one service with a QoS indicator in the set of QoS indicators;
the random access procedure being triggered by at least one event in the set of random access events;
the UE having at least one capability in the set of UE capabilities; or
the UE having available UE information in the set of UE information availability.

15. The BS of claim 13, wherein the non-signal-strength offset comprises at least one of:
a time offset associated with the time threshold, or
a distance offset associated with the distance threshold.

16. A processor for wireless communication, comprising:
at least one controller coupled with at least one memory and configured to cause the processor to:
receive configuration information associated with repetition of a random access message; and
determine whether to transmit a request for the random access message with repetition or determine whether to transmit the random access message with repetition for a random access procedure based on the 6 configuration information, wherein the configuration information at least indicates one of:
a signal strength parameter and a signal strength offset associated with the signal strength parameter;
a non-signal-strength parameter;
a non-signal-strength parameter and a non-signal-strength offset associated with the non-signal-strength parameter; or
a signal strength parameter and a non-signal-strength parameter.

17. The processor of claim 16, wherein the random access message comprises one or more of Msg3 in a 4-step random access procedure or MsgA payload for 2-step random access procedure.

18. The processor of claim 16, wherein the at least one controller is further configured to cause the processor to:
determine to transmit the request for the random access message with repetition or transmit the random access message with repetition in a case that a receiving signal strength at a user equipment (UE) is one or more of smaller than the signal strength parameter, or smaller than the signal strength parameter plus the signal strength offset.

19. The processor of claim 16, wherein the non-signal-strength parameter comprises at least one of:
a time threshold;
a distance threshold;
a set of geographical areas;
a set of logical channels;
a set of quality of service (QOS) indicators;
a set of random access events;
a set of UE capabilities; or
a set of UE information availability.

20. A method performed by a user equipment (UE), the method comprising:
receiving configuration information associated with repetition of a random access message; and
determining whether to transmit a request for the random access message with repetition or determine whether to transmit the random access message with repetition for a random access procedure based on the configuration information, wherein the configuration information at least indicates one of:
a signal strength parameter and a signal strength offset associated with the signal strength parameter;
a non-signal-strength parameter;
a non-signal-strength parameter and a non-signal-strength offset associated with the non-signal-strength parameter; or
a signal strength parameter and a non-signal-strength parameter.
